(19) United States
(12) Patent Application Publication
(10) Pub. No.: US 2007/0068517 A1
(43) Pub. Date: Mar. 29, 2007

(54) Composition for use with artificial airway devices

(76) Inventor: Steven S. Crohn, Paradise Valley, AZ (US)

Correspondence Address: MICHAEL E. ZALL, TWO YORKSHIRE DRIVE, SUFFERN, NY, 10901, US

(21) Appl. No.: 11/237,541

(22) Filed: Sep. 29, 2005

(51) Int. Cl. A62B 7/00

(52) U.S. Cl. 128/200.24

(57) ABSTRACT

A composition for applying to an artificial airway device that facilitate lung ventilation, e.g., oropharyngeal masks, and endotracheal tubes, prior to introduction into an air passageway of a patient. The composition includes a) an effective lubricating amount of a safe and effective water based lubricant, b) an effective antibacterial amount of a non-antibiotic biocide for inhibiting the growth of bacteria in the air passageway, preferably xylitol, and c) an effective anti-nausea amount of an anti-nausea composition to inhibit nausea in the patient, preferably peppermint extract.

### BACKGROUND OF THE INVENTION

1. Field of the Invention

This invention relates to compositions that have sealing, lubricating, antibacterial and anti-nausea properties for use with artificial airway devices that facilitate lung ventilation, e.g., oropharyngeal masks, and endotracheal tubes.

2. Description of the Related Art

Artificial airway devices to facilitate lung ventilation in an unconscious person during surgery or in emergencies are well known. Examples of commercially available laryngeal masks are described in U.S. Pat. Nos. 4,509,514 and 5,303,697 to Brain. In particular, in order to maintain an open airway of an unconscious patient it is normal practice in general anaesthesia to use an endotracheal tube, which is a flexible tube of rubber or plastics, usually with an inflatable cuff around the distal end. Alternatively, an oro- or naso-pharyngeal airway may be used, which is a flexible tube extending from the mouth or nose into the pharynx but not into the larynx. In anaesthesia, such an airway is used in conjunction with a face mask.

Typically, the endotracheal tube is introduced through the larynx into the trachea or windpipe, whereupon the cuff is inflated through a small auxiliary tube to seal against the wall of the trachea. Introduction of the endotracheal tube is a skilled operation normally requiring use of a laryngoscope to smoothly guide the tube through the larynx, past the vocal cords and into the trachea. There is a risk that the tube or the laryngoscope as it is inserted may cause damage to soft tissues or to the sensitive structures of the larynx while it passes over these areas. Placing of the tube in the trachea effectively narrows the interior passage of the lumen of the trachea and provides a potential source of damage thereto by frictional or pressure injury and the development of an infection. Such devices prevent the normal upward flow of mucus from the trachea, rendering effective coughing impossible and causing nausea.

There is thus the need for effective means for easing the entrance of these devices into a patient and for inhibiting or preventing the onset of infection and nausea.

U.S. Pat. No. 6,350,251 to Prosl et al. discloses biocidal/anticoagulant compositions for flushing and coating internal prosthetic devices, e.g., catheters and ports for hemodialysis access systems, that come in contact with blood and pierce the patients skin. A “biocidal lock solution” is described which contains an anticoagulant and a non-antibiotic biocide. The valve seal and needle use a water-based lubricant prior to insertion. Sugar alcohols such as xylitol along with taurodine are used to maintain anti-bacterial activity.

U.S. Pat. No. 6,663,883 to Akiyama et al. discloses a matrix that adheres to the nasal mucosa which allows improved transfer into the brain of a drug. The matrix adheres to the nasal mucosa and may contain peppermint oil. A pharmaceutical additive, e.g., excipient as such as xylitol, may be used in amounts where the adhesion of the solid preparation to the nasal mucosa is not deteriorated.

US Patent Application No. 2004/0255951 to Grey discloses the cuff balloon and/or tube surfaces of an endotracheal tube may be impregnated, comprise or be coated with an anti-microbial solution for preventing the colonization of bacteria as well as the use of a water-based lubricant, such as Surgilube, to reduce friction between the two elements (the monorail and bi-rail) when inserting the suction catheter of the endotracheal tube.

US Patent Application No. 2002/0176827 to Rajaiah et al. discloses a dental strip that releases actives and contains a polybutene that acts as a lubricant on the teeth and may contain peppermint oil as a fragrance and/or sensate agent (warming or cooling agent) and xylitol as a sweetener.

Additional references of interest are:

US Patent Application No. 2002/0020414 to Fukonaga discloses a kit that includes an assisted ventilation device and an antibiotic salve.

US Patent Application No. 2001/0025015 to Volker et al discloses a non-digestible fat containing xylitol.

U.S. Pat. No. 5,620,004 to Johansen discloses an airway indicator device for verifying the correct placement of an endotracheal tube.

As indicated, the use of artificial airway devices present a risk that the tube or the laryngoscope may cause damage to soft tissues or to the sensitive structures of the larynx. Such devices provide a potential source of damage to these structures through infection, pressure and friction while being inserted in place. Such devices also prevent the normal upward flow of mucus from the trachea, rendering effective coughing impossible and thus creating the possibility of nausea in the patient. Notwithstanding existing contributions to the art, a need continues to exist for a safe and effective method for easing the introduction of such artificial airway devices through the airway passages to prevent damage to soft tissue and other structures of the larynx and preventing infection and nausea in patients who use of such devices.

### OBJECTS AND SUMMARY OF INVENTION

It is an object of this invention to provide a composition for application to an artificial airway device that facilitates lung ventilation, particularly for anesthetizing patients, that is a sealant, lubricant, antibacterial and anti-nausea composition.

It is yet another object of this invention to provide a composition that is easy to apply, safe and efficacious for use on oropharyngeal masks, endotracheal tubes and the like, that permits such devices to be easily introduced into the air passageway, assists in sealing the devices to prevent air/gas leakage, inhibits the promotion of bacteria and inhibits nausea in the patent.

All of the foregoing objects as well as others are achieved by the composition of this invention. The composition is applied to an artificial airway device that facilitates lung ventilation, e.g., oropharyngeal masks, and endotracheal tubes, prior to introduction into an air passageway of a patient. The composition includes a) an effective lubricating amount of a safe (medically acceptable) and effective water based lubricant, b) an effective antibacterial amount of a non-antibiotic biocide for inhibiting the growth of bacteria in the air passageway, preferably xylitol, and c) an effective anti-nausea amount of an anti-nausea composition to inhibit nausea in the patient, preferably peppermint extract.

Additionally, this invention is directed to a method of introducing an artificial airway device into an air passageway of a patient. The method comprises a) providing an artificial airway device that includes contact surfaces that contact the air passageway of the patient, b) applying to substantially all of the contact surfaces the composition of this invention, and c) introducing the so treated airway device into the air passageway of the patient.

The airway device can be smoothly introduced into the air passageway, the composition providing lubrication and sealing between the contact surfaces and air passageway, inhibiting the growth of bacteria therein and inhibiting nausea in the patient.

### BRIEF DESCRIPTION OF THE DRAWINGS

For a more complete understanding of the present invention, reference may be had to the following description of the exemplary preferred embodiments of the present invention considered in connection with the accompanying drawings, of which:

FIG. 1 is a perspective view of a laryngeal mask showing the application of the composition of this invention to the contact surfaces of the mask, i.e., the inflatable cuff, prior to insertion of the device into the patient;

FIG. 2 is a schematic of the insertion of the laryngeal mask into a patient; and

FIG. 3 is schematic of the laryngeal mask in place in a patent while the cuff is being inflated.

### DETAILED DESCRIPTION OF THE INVENTION

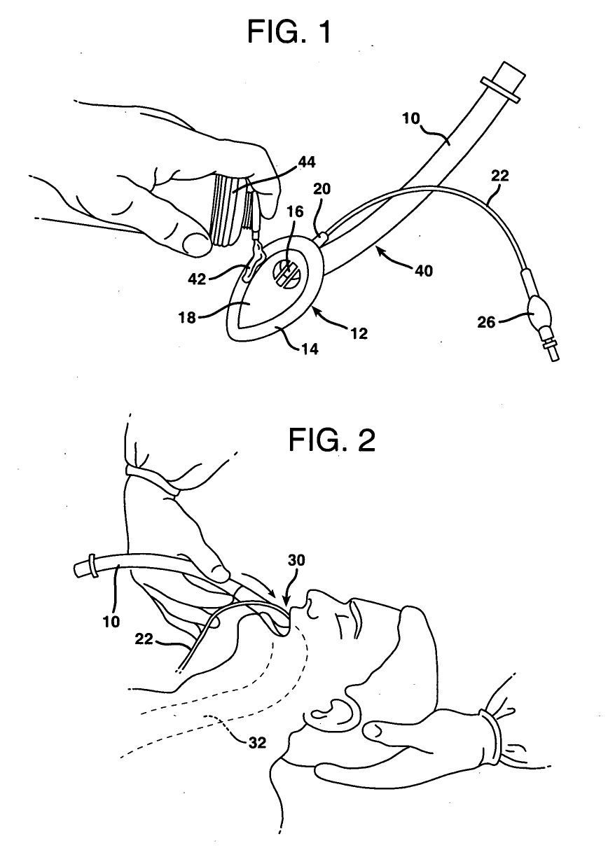

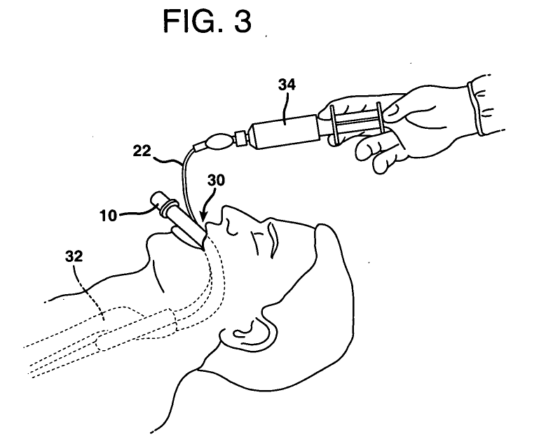

An example of an artificial airway device 40, a laryngeal mask, that uses the compositions of this invention is illustrated in FIG. 1-3. Referring to FIG. 1, such mask a comprises a flexible tube 10 made of a soft plastic material and a mask portion 12 of flexible rubber sheet material with an inflatable tubular ring 14 of the same rubber material. The distal end 16 of the plastic tube 10 opens into the interior or lumen 18 of the mask portion 12 and is sealed into the mask 12 in an airtight manner so as to form a semi-rigid spine for the mask. The inflatable rubber ring 14 is of roughly elliptical shape. The ring 14 is formed with a port 20 into which is sealed one end of a flexible plastics tube 22 of much smaller diameter. The other end of tube 22 is provided with an inflation indicator and a non-return valve 26, and can be connected to a small pump such as a disposable medical syringe 34 (FIG. 3) for inflation of the ring 14.

Referring to FIGS. 2 and 3, in use, the device is inserted through the patient's mouth 30 and down through the throat 32 past the epiglottis until the mask 12 comes to rest with the ring 14 in the base of the throat, lying against the upper end of the normally closed oesophagus which the mask cannot easily enter because of its size and shape. The ring 14 is then inflated as shown in FIG. 3 with medical syringe 34 to seal around the inlet to the larynx. The patient's airway is thus secure and unobstructed and the laryngeal mask can be connected directly to conventional anaesthetic circuit hosing for either positive pressure or spontaneous breathing.

As shown in FIG. 1, prior to insertion of the artificial airway device 40 into the air passageway of a patient, the surfaces that contact the air passageway of the patient are treated by applying the composition of this invention thereto. In particular, in the example shown, the composition 42 is applied to the outer surfaces of the tubular ring 14. Other surfaces, e.g., tube 10, interior 18, etc. may also be treated with the composition 42 as long as the air passageways are not blocked.

As shown in FIG. 1, the composition may be applied by a spray cannister 44 containing the composition 42. However, any method of application is contemplated, e.g., swabbing with a saturated cloth, rubbing by hand, dipping into a solution of the composition, etc. It is also contemplated that the devices may be “precoated” in that the compositions are applied to the devices during the manufacturing process, packaged and then shipped to locations of use.

Broadly, the composition of this invention is a water based composition comprising:

I) an effective, lubricating amount of a safe, medically acceptable effective water based lubricant;

ii) an effective antibacterial amount of a non-antibiotic biocide for inhibiting the growth of bacteria in the air passageway; and

iii) an effective anti-nausea amount of peppermint extract to inhibit nausea in the patient;

The treated airway device 40 is introduced into the air passageway of the patient. The application of the composition to the surfaces of the device permit it to be smoothly introduced into the air passageway, providing a seal between the contact surfaces and air passageway, and inhibiting the growth of bacteria therein and nausea in the patient.

The lubricant is a water based lubricant that is safe, i.e., medically acceptable, and effective in use. Such lubricant's are well known in the art, for example, KY (Johnson & Johnson). The lubricant is present in the composition at a concentration sufficient to provide adequate lubrication when the composition is applied. Typically the lubricant is a substantial portion of the composition.

The composition additionally includes an effective antibacterial amount of a non-antibiotic biocide for inhibiting the growth of bacteria in the air passageway. The term “biocide,” as used herein, means an agent that destroys, inhibits and/or prevents the propagation, growth, multiplication and the like of unwanted organisms. The term organisms includes microorganisms, bacteria, undulating bacteria, spirochetes, spores, spore-forming organisms, gram-negative organisms, gram-positive organisms, yeasts, fungi, molds, viruses, aerobic organisms, anaerobic organisms, mycobacteria, and the like. The biocide employed in the practice of the present invention is one that is a “non-antibiotic,” i.e., it is not an antibiotic. Such non-antibiotic biocides are well known in the art, see for example U.S. Pat. No. 6,350,251 to Prosl et al., the entire disclosure of which is incorporated herein by reference.

The biocide is employed in the composition of this invention to kill, cleanse, prevent, and/or retard or inhibit the presence or propagation of harmful or unwanted micro-organisms or the spores of micro-organisms, viruses and the like.

Of the numerous non-antibiotic biocides available, the preferred ones for use in the practice of this invention are polyols such as carbohydrates, e.g., hexoses, such as, glucose, fructose, and mixtures thereof; pentoses, such as, xylose; polysaccharides, such as, dextran or hydrolyzed starch; glycerol; and sugar alcohols, such as, erythritol, sorbitol, mannitol, maltitol, isomalt and xylitol. Xylitol is most preferred. The concentration of the polyol should be just an amount sufficient to be effective and not cause airway or mucous membrane irritation.

The composition further includes an effective anti-nausea amount of an anti-nausea composition to inhibit nausea in the patient. Suitable components include menthol, menthyl lactate, wintergreen oil, peppermint oil, spearmint oil, leaf alcohol, camphor, clove bud oil, eucalyptus oil, anethole, methyl salicylate, eucalyptol, cassia, 1-8 menthyl acetate, eugenol, oxanone, alpha-irisone, propenyl guaethol, cinnamon, thymol, linalool, benzaldehyde, cinnamaldehyde glycerol acetal known as CGA, and mixtures thereof. The preferred compound for use is a peppermint oil or extract. The anti-nausea composition is present in sufficient amount to be effective in preventing nausea. Such amount can be easily determined by tests well known.

The foregoing constitutes a description of specific embodiments showing how the invention may be applied and put into use. These embodiments are only exemplary. The invention in its broadest, and more specific aspects, is further described and defined in the claims which now follow.

These claims, and the language used therein, are to be understood in terms of the variants of the invention which have been described. They are not to be restricted to such variants, but are to be read as covering the full scope of the invention as is implicit within the invention and the disclosure.

1. A composition for applying to an artificial airway device prior to introduction into an air passageway of a patient, the composition comprising:
a) an effective lubricating amount of a safe and effective water based lubricant;
b) an effective antibacterial amount of a non-antibiotic biocide for inhibiting the growth of bacteria in the air passageway; and
c) an effective anti-nausea amount of an anti-nausea composition to inhibit nausea in the patient.

2. A composition for applying to an artificial airway device prior to introduction into an air passageway of a patient, the composition comprising:
a) an effective lubricating amount of a safe and effective water based lubricant;
b) an effective antibacterial amount of a sugar alcohol for inhibiting the growth of bacteria in the air passageway; and
c) an effective anti-nausea amount of peppermint extract to inhibit nausea in the patient.

3. The composition of claim 2, wherein the sugar alcohol is selected from the group consisting of erythritol, sorbitol, mannitol, maltitol, isomalt and xylitol.

4. The composition of claim 2, wherein the sugar alcohol is xylitol.

5. A method of introducing an artificial airway device into an air passageway of a patient, comprising:
a) providing an artificial airway device that includes contact surfaces that contact the air passageway of the patient;
b) applying to substantially all of the contact surfaces a composition comprising:
i) an effective lubricating amount of a safe and effective water based lubricant;
ii) an effective antibacterial amount of a non-antibiotic biocide for inhibiting the growth of bacteria in the air passageway; and
iii) an effective anti-nausea amount of an anti-nausea composition to inhibit nausea in the patient;
c) introducing the so treated airway device into the air passageway of the patient,
whereby the device can be smoothly introduced into the air passageway, the composition providing lubrication and sealing between the contact surfaces and air passageway, inhibiting the growth of bacteria therein and inhibiting nausea in the patient.

6. A method of introducing an artificial airway device into an air passageway of a patient, comprising:
a) providing an artificial airway device that includes contact surfaces that contact the air passageway of the patient;
b) applying to substantially all of the contact surfaces a composition comprising:
i) an effective lubricating amount of a safe and effective water based lubricant;
ii) an effective antibacterial amount of a sugar alcohol for inhibiting the growth of bacteria in the air passageway; and
iii) an effective anti-nausea amount of peppermint extract to inhibit nausea in the patient;
c) introducing the so treated airway device into the air passageway of the patient,
whereby the device can be smoothly introduced into the air passageway, the composition providing lubrication and sealing between the contact surfaces and air passageway, inhibiting the growth of bacteria therein and inhibiting nausea in the patient.

7. The method of claim 6, wherein the sugar alcohol is selected from the group consisting of erythritol, sorbitol, mannitol, maltitol, isomalt and xylitol.

8. The method of claim 6, wherein the sugar alcohol is xylitol.

9. A composition comprising:
a) an amount of a safe and effective water based lubricant;
b) an effective antibacterial amount of a non-antibiotic biocide for inhibiting the growth of bacteria in the air passageway; and
c) an effective anti-nausea amount of an anti-nausea composition to inhibit nausea in the patient.

10. A composition comprising:
a) a lubricating amount of a safe and effective water based lubricant;
b) an effective antibacterial amount of a sugar alcohol for inhibiting the growth of bacteria in the air passageway; and
c) an effective anti-nausea amount of peppermint extract to inhibit nausea in the patient.

11. The composition of claim 10, wherein the sugar alcohol is selected from the group consisting of erythritol, sorbitol, mannitol, maltitol, isomalt and xylitol.

12. The composition of claim 10, wherein the sugar alcohol is xylitol.
